(19) United States
(12) Patent Application Publication
(10) Pub. No.: US 2020/0367470 A1
(43) Pub. Date: Nov. 26, 2020

(54) METHOD AND ARRANGEMENT FOR IDENTIFYING ANIMALS

(71) Applicant: Siemens Aktiengesellschaft, München (DE)

(72) Inventors: Thomas Baudisch, Schondorf am Ammersee (DE); Rainer Falk, Poing (DE); Jens Renner, Herzogenaurach (DE); Rudolf Sollacher, Eching (DE)

(73) Assignee: Siemens Aktiengesellschaft, München (DE)

(21) Appl. No.: 16/767,617

(22) PCT Filed: Oct. 17, 2018
(86) PCT No.: PCT/EP2018/078423

§ 371 Date: May 28, 2020

(30) Foreign Application Priority Data
Dec. 7, 2017 (EP) 17205903.2

(51) Int. Cl. A01K 11/00; G06K 9/00

(52) U.S. Cl. CPC A01K 11/006; G06K 9/00288; G06K 9/00362

(57) ABSTRACT

A method and assembly for identifying animals, wherein according to the invention, for the identification of an animal, first a sensor checks whether a body part of the animal to be identified is in a predefined position is provided. With a positive test result, an imaging sensor is prompted to capture an image of the nose of the animal. According to the invention, by means of a pattern recognition method, a texture of the nose is then detected on the captured image and extracted and the animal is assigned a unique identifier based on the extracted nose texture.

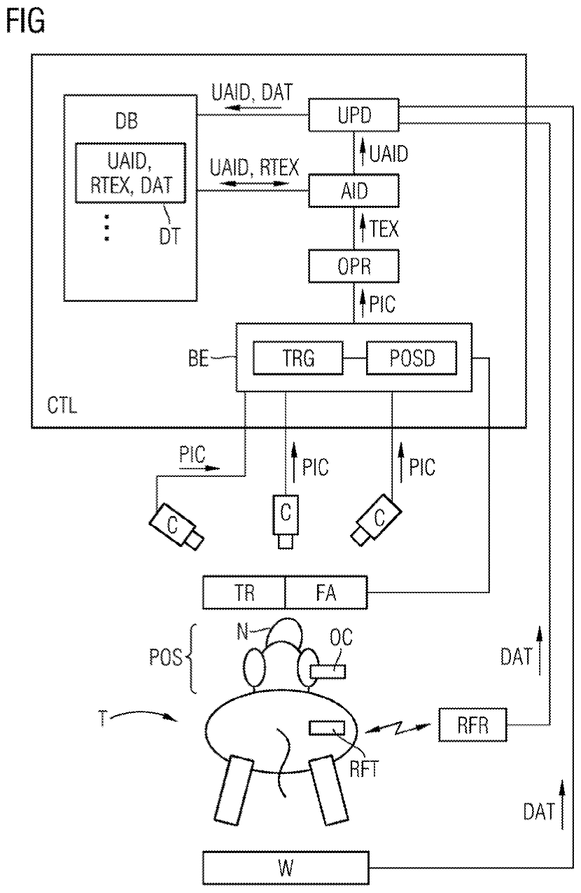

### CROSS-REFERENCE TO RELATED APPLICATIONS

This application claims priority to PCT Application No. PCT/EP2018/078423, having a filing date of Oct. 17, 2018, which is based on European Application No. 17205903.2, having a filing date of Dec. 7, 2017, the entire contents both of which are hereby incorporated by reference.

### FIELD OF TECHNOLOGY

In professional or private animal husbandry, it is often necessary, or at least desirable, to uniquely identify animals. To this end, the animals are frequently provided with labels, such as ear clips, foot rings, RFID tags, collars or brand marks. However, such markers need to be applied in advance and can subsequently be lost or reused in impermissible fashion.

### BACKGROUND

A nose print of the animal is often used for identification purposes, particularly in the case of cattle and sheep. However, capturing such a nose print requires comparatively large amounts of effort, forasmuch as the animal has to be immobilized first, the nose has to be cleaned, dye has to be applied to the nose and a print of the nose has to be taken.

### SUMMARY

An aspect relates to a method and an arrangement for identifying animals, which allow quick and reliable identification.

According to embodiments of the invention, a test is carried out by means of a first sensor for the purposes of identifying an animal, to find out whether a body part of the animal to be identified is located at a predetermined position. A positive test result prompts an imaging sensor to record an image of a nose (N) of the animal. Then, according to embodiments of the invention, a texture of the nose is recognized in the recorded image and extracted by means of a pattern recognition method and the animal is assigned a unique identifier on the basis of the extracted nose texture.

Here, in particular, a position sensor, a photoelectric barrier, scales, a camera or the imaging sensor can be used as the first sensor. The body part whose position is tested by the first sensor can be the nose or the head of the animal in particular. An optical camera, an infrared camera, a hyperspectral camera, and/or an ultrasonic sensor can be used as imaging sensor. In particular, one or more 2D or 3D cameras can be used in the process.

To carry out the method according to embodiments of the invention, an arrangement for identifying animals, a computer program product (non-transitory computer readable storage medium having instructions, which when executed by a processor, perform actions), and a computer-readable storage medium are provided.

A substantial advantage of embodiments of the invention should be considered to be the fact that capturing a nose texture, which is largely secured against manipulation as it is a biometric feature, by means of an imaging sensor facilitates a quick and, at the same time, reliable identification of the animal. Moreover, a nose texture can frequently still be ascertained with sufficient reliability by suitable image processing methods, even in the case of moderate dirtying of the nose.

Advantageous embodiments and developments of the invention are specified in the dependent claims.

According to one advantageous embodiment of the invention, a plurality of imaging sensors can be provided, which record a plurality of images of the nose from different directions. Then, the nose texture can be extracted on the basis of the images recorded from different directions. In particular, a sufficiently accurate height profile of the surface of the nose, which, as a nose texture, is generally a characteristic of an animal, can be ascertained on the basis of the images recorded from different directions using standard processes from image evaluation. Moreover, identification reliability of the nose texture can be increased by evaluating a plurality of images.

Advantageously, a portion of the nose where the nose texture is optically capturable can be ascertained on the basis of a recorded image by way of a comparison with predetermined nose features. Then, the nose texture can be extracted from the ascertained portion. In particular, this allows a less dirtied portion of the nose to be identified and/or delimited. The nose features may relate to structure, color and/or brightness of the nose.

A fraction of an overall area of the nose taken up by the portion can be ascertained and the identification can be continued, the identification can be terminated and/or a further image can be recorded depending on this fraction. In particular, the ascertained fraction can be compared to a threshold of 60% or 80%, for example, and may be processed further depending on the result of the comparison.

Furthermore, specific texture features, such as lines, points and/or areas, for example, can be extracted from the nose texture by the pattern recognition method. Hence, the identification can be continued, the identification can be terminated and/or a further image can be recorded depending on a number of extracted texture features. Thus, provision can be made, for example, for the identification to be continued if six or more texture features can be extracted and for the identification to be otherwise terminated or repeated.

As a rule, this can ensure that the captured texture features suffice for a unique and reliable identification.

According to an advantageous development of embodiments of the invention, a marker attached to or in the animal, e.g., an earmark and/or an RFID tag, can be captured by a further sensor and a test can be carried out as to whether the marker and the unique identifier are assigned to the same animal. This can increase the reliability of the identification, verify the attached marker and/or identify the manipulation thereof.

Further, a marker attached to or in the animal, e.g., an earmark and/or an RFID tag, can be captured by a further sensor and a reference texture can be selected on the basis of the captured marker. The selected reference texture can then be compared to the extracted nose texture and, in the case of correspondence, a reference identifier of the reference texture can be assigned as unique identifier.

Moreover, the extracted nose texture can be compared to a multiplicity of reference textures. A reference identifier of a reference texture corresponding to the nose texture can then be assigned as unique identifier.

According to further advantageous development of embodiments of the invention, an automated feeder can be prompted to release feed for the animal by a positive test result of the first sensor, by successfully recording the image, by successfully identifying or extracting the nose texture, and/or by successfully assigning the identifier. The imaging sensor is disposed at the automated feeder. This is advantageous inasmuch as an animal to be identified usually moves to the automated feeder independently and need not be transported there with much effort. Moreover, the release of feed coupled with a successful performance of the method steps leads the animal to learn to position itself, usually without further assistance, so that there can be reliable identification.

Furthermore, the imaging sensor can be disposed at a trough and the first sensor can carry out a test as to whether the body part of the animal is situated at the trough. This is advantageous inasmuch as the water in the trough generally cleans the nose of the animal, and so the optical structures thereof can be captured better.

According to a further advantageous embodiment of the invention, details about the animal can be retrieved from a database on the basis of the identifier and the animal can be treated depending on the retrieved details. In particular, the details may contain individual data about a history, an origin, breeding, fattening, and/or transportation of the animal, and health data, veterinary treatment data, data about medicaments or vaccines administered, and insurance details. Moreover, the details may comprise reference images, in particular reference textures, texture features extracted therefrom, and further identification information such as, e.g., identifiers of earmarks or RFID tags. By way of example, the type and/or amount of feed or medicaments given to the animal can be controlled on the basis of the details.

Furthermore, it is possible to capture data relating to the animal. The captured data and the identifier can be transmitted to a database, wherein details about the animal assigned to the identifier are updated on the basis of the captured data. The data to be updated may comprise, in particular, measured values such as, e.g., size, weight and body temperature of the animal, a pH value in the rumen or a currently captured nose texture. In particular, updating the stored nose textures increases the reliability of an identification since, for example, age-related changes in the nose textures can be taken into account in future identifications.

### BRIEF DESCRIPTION

Some of the embodiments will be described in detail, with reference to the following FIGURES, wherein like designations denote like members, wherein:

The FIGURE shows an arrangement according to embodiments of the invention for identifying animals in a schematic representation.

### DETAILED DESCRIPTION

The FIGURE represents an arrangement according to embodiments of the invention for identifying an animal T. Here, the animal T can be, in particular, a farm animal, such as, e.g. a cow, a sheep, a pig or a horse, or a wild animal or a pet. A control device CTL is provided for controlling the animal identification and a plurality of cameras C, an automated feeder FA, scales W and an RFID (radio frequency identification) reader are coupled thereto.

As imaging sensors, the cameras C have different functions within the scope of animal identification. In particular, the cameras C are used to record images PIC of a nose N of the animal T from different directions. To this end, the cameras C are disposed around a predetermined position POS for a head or the nose N of the animal. The position POS is predetermined in such a way that images PIC of the nose N with detailed structures and also, images of an ear clip OC attached to the animal T can be recorded. In particular, cameras for visible light, infrared cameras, hyperspectral cameras and/or ultrasonic sensors can be used as imaging sensors C. Here, use can be made of 2D or 3D cameras.

In the present example embodiment, the cameras C furthermore act as position sensors for determining whether the head, the nose N or any other body part of the animal T is situated in the predetermined position POS. To this end, one or more images recorded by the cameras C are transmitted to an image capture module BE of the control device CTL. The image capture module BE has a position detection POSD, which, on the basis of the recorded images, carries out a test as to whether the head, the nose N, and/or a different body part of the animal T is situated in the predetermined position POS. A positive test result causes a trigger TRG of the image capture module BE to prompt the cameras C to record the pictures PIC of the nose N from different directions. To this end, the trigger TRG is coupled to the position detection POSD.

Furthermore, the positive test result causes the trigger TRG to prompt an automated feeder FA, coupled to the image capture module BE, to release feed for the animal T following a successful image recording or a successful identification. the cameras C are disposed at or near the automated feeder FA. This is advantageous inasmuch as, as a rule, a respective animal T will move to the automated feeder FA independently and can therefore be identified without further transportation outlay. Moreover, the release of feed linked to successful image recording or identification leads the animal T to learn to position itself, usually without further assistance, so that there can be reliable identification. Accordingly, the posture of the head or the nose N of the animal T typically adopted by the animal T in front of an automated feeder is specified as position POS for triggering the image recording.

Furthermore, a trough TR is disposed by the automated feeder FA and hence by the cameras C. This is advantageous inasmuch as the nose N of the animal T is, as a rule, cleansed by the water in the trough TR, and so the optical structures of the nose are better capturable by the cameras C.

Advantageously, the cameras C can also be movably disposed and can be moved into a position, suitable for recording, around the head or the nose N of the animal T on the basis of an ascertained position or posture of the animal T.

As an alternative or in addition thereto, a photoelectric barrier can be used as a position sensor or the scales W can be used as a sensor for identifying whether the animal T is situated in a position that is suitable for recording the nose N. Accordingly, the recording of the images PIC can be triggered by the photoelectric barrier or the scales W.

The recorded images PIC of the nose N are captured by the image capture module BE and are transmitted to an optical pattern recognition means OPR, coupled to the image capture module BE, of the control device CTL.

The optical pattern recognition means OPR ascertains a height profile of the surface of the nose N from the images PIC that were recorded from different directions and identifies and extracts a texture TEX of the nose N therefrom. The nose texture TEX substantially corresponds to a nose print taken in conventional fashion and is an individual biometric feature of the animal T that is largely unforgeable.

A multiplicity of optical pattern recognition methods are available for identifying and extracting the nose texture TEX, e.g., methods for biometric user authentication for cellular telephones.

In the present example embodiment, image features of the recorded images PIC are compared to predetermined nose features by the optical pattern recognition means OPR and, depending thereon, a portion of the nose N where the nose texture TEX is optically capturable and not covered by dirt or other obstacles is ascertained. In the further identification method, only the nose texture TEX extracted from the ascertained portion is then processed further. The predetermined nose features may relate to, e.g., a brightness, a color and/or a structure of the nose N.

The optical pattern recognition means OPR can ascertain a fraction of an overall area of the nose N taken up by the portion and the identification can be continued, the identification can be terminated, or a further image can be recorded depending on this fraction. In particular, the ascertained fraction can be compared to a threshold of 60% or 80%, for example, and the identification is only continued if the threshold is exceeded. As an alternative or in addition thereto, the optical pattern recognition means OPR can identify and extract specific texture features of the nose N, e.g., lines, points and/or areas, and the identification can be continued, the identification can be terminated or a further image can be recorded depending on a number of extracted texture features. Here, provision can be made for, e.g., the identification only to be continued if six or more of such texture features can be extracted.

The extracted nose texture TEX is transmitted from the optical pattern recognition means OPR to an animal identification module AID, coupled therewith, of the control device CTL. The animal identification module AID is used to identify and authenticate the animal T on the basis of its nose texture TEX.

The animal identification module AID is coupled to a database DB of the control device CTL. A so-called digital twin DT is stored in the database DB for each of the multiplicity of animals, all relevant data about the respective animal being combined in the digital twin. A respective digital twin DT is individually assigned to a respective animal and contains a unique reference identifier UAID (universal animal identification) of the respective animal, at least one reference texture RTEX of the nose of the respective animal and further details DAT about the respective animal. The reference textures RTEX and the details DAT of the digital twin DT can be stored, in particular, in unforgeable fashion in a blockchain. A respective reference texture RTEX can be stored, e.g., in the form of one or more reference images of the nose of the respective animal or in the form of extracted image features or feature vectors. In the present example embodiment, the reference identifier UAID is used as unique identifier of the respective animal T.

The details DAT about a respective animal T are in each case individually assigned to the identifier UAID and hence to this respective animal T. In particular, the details DAT may comprise details about the history of the animal T, data about its origin, its breeding, its fattening and/or its transport. Moreover, it may contain health data, veterinary treatment data, data about administered medicaments or received vaccinations, insurance details, details about the amount, type and/or dispensation of feed and data about medicaments to be dispensed.

The extracted nose texture TEX of the animal T is compared to the reference textures RTEX of the digital twins DT stored in the database DB using the animal identification module AID. In the case of a sufficient correspondence of one of the reference textures RTEX with the extracted nose texture TEX, the reference identifier UAID assigned to the corresponding reference texture is assigned to the animal T as a unique identifier and hence the animal T is identified and/or authenticated.

According to the present example embodiment, the ear clip OC or any other marker attached to or in the animal is captured by a further sensor and a specific label, e.g., a character combination, is extracted as further identification information.

In particular, one or more of the cameras C can act as a further sensor. Thus, an individual character combination attached to the ear clip OC can be recognized and extracted in an image thereof, recorded by the camera C, by means of the optical pattern recognition means OPR. As an alternative or in addition thereto, one or more RFID tags, attached to the ear clip OC, to a collar or to or in the animal, can be read by means of an RFID reader in order to extract a specific label. Following an extraction of the specific label, it is possible to test whether or not this and the ascertained unique identification are assigned to the same animal T. If not, a warning about an unsuccessful authentication can be output. This allows a test to be carried out as to whether a manipulable marker, such as the ear clip OC, for example, has been impermissibly attached to another animal. Such a warning can also be output if a reference structure RTEX assigned to the specific label in the database DB does not correspond to the captured nose texture TEX.

By additionally checking markers attached to the animal T, the ear clip OC in this case, and by comparing these to the captured biometric features, the nose texture TEX in this case, it is possible to significantly increase identification reliability. Moreover, impermissible manipulations can be identified more easily.

As soon as the animal T has been successfully identified or authenticated, the details DAT of the identified animal T can be retrieved from the database DB on the basis of the identifier UAID and the animal can be treated on the basis thereof. By way of example, depending on the retrieved details DAT, an amount, a type and/or a manner of dispensation of medicaments or of the feed to be output by the automated feeder FA can be controlled.

Furthermore, the control device CTL has a data updating module UPD that is coupled to the database DB and the animal identification module AID. The data updating module serves to update the digital twin DT of a respectively identified animal T in the database DB and, in particular, to update the details DAT about this animal T.

Within the scope of the identification of the animal T, the ascertained identifier UAID is transferred from the animal identification module AID to the data updating module UPD, which, on the basis of the identifier UAID, accesses the digital twin DT of the animal T identified by this identifier UAID.

In the present example embodiment, a weight the animal T is measured by the scales W in the context of animal identification. Furthermore, a pH value in the rumen is read by the RFID reader RFR from an RFID tag RFT, a so-called rumen tag, located in the rumen of the animal T. The scales W and the RFID reader RFR are coupled to the data updating module UPD and transfer the measured weight and the measured pH value as current details DAT to the data updating module UPD. The data updating module UPD transfers the measured details DAT together with the identifier UAID as access information to the database DB and thereby prompts an update of the details DAT stored in the digital twin DT of the identified animal T. In analogous fashion, it is also possible to measure a body temperature of the animal T, e.g., by means of an infrared camera, and store this in the digital twin DT of the animal T.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for identifying animals, wherein;
a) carrying out a test by means of a first sensor to find out whether a body part of an animal to be identified is located at a predetermined position;
b) prompting an imaging sensor to record an image of a nose of the animal based upon a positive test result;
c) recognizing a texture the nose in the recorded image and extracted by means of a pattern recognition method; and
d) assigning the animal a unique identifier on the basis of the extracted nose texture.

2. The method as claimed in claim 1, wherein a plurality of imaging sensors are provided, in that a plurality of images of the nose are recorded from different directions by means of the imaging sensors, and in that the nose texture is extracted on the basis of the images recorded from the different directions.

3. The method as claimed in claim 1, wherein a portion of the nose where the nose texture is optically capturable is ascertained on the basis of the recorded image by means of a comparison with predetermined nose features and in that the nose texture is extracted from the ascertained portion.

4. The method as claimed in claim 3, a fraction of an overall area of the nose taken up by the portion is ascertained and in that the identification is continued, the identification is terminated or a further image is recorded depending on this fraction.

5. The method as claimed in claim 1, wherein specific texture features are extracted from the nose texture by the pattern recognition method and in that the identification is continued, the identification is terminated or a further image is recorded depending on a number of extracted texture features.

6. The method as claimed in claim 1, wherein a marker attached to or in the animal is captured by a further sensor and in that a test is carried out to find out whether the marker and the unique identifier are assigned to the same animal.

7. The method as claimed in claim 1, wherein a marker attached to or in the animal is captured by a further sensor, in that a reference texture is selected on the basis of the captured marker, in that the selected reference texture is compared to the extracted nose texture, and in that a reference identifier of the reference texture is assigned as unique identifier in the case of correspondence.

8. The method as claimed in claim 1, wherein extracted nose texture is compared to a multiplicity of reference textures and in that a reference identifier of a reference texture corresponding to the nose texture is assigned as unique identifier.

9. The method as claimed in claim 1, wherein an automated feeder is prompted to release feed for the animal by a positive test result of the first sensor, by successfully recording the image by successfully identifying or extracting the nose texture, and/or by successfully assigning the identifier.

10. The method as claimed in claim 1, wherein the imagining sensor is disposed at a trough and in that the first sensor carries out a test as to whether the body part of the animal is situated at the trough.

11. The method as claimed in claim 1, wherein details about the animal are retrieved from a database on the basis of the identifier and in that the animal is treated depending on the retrieved details.

12. The method as claimed in claim 1, wherein the data relating to the animal are captured, in that the identifier and the captured data are transmitted to a database, and in that the details about the animal assigned to the identifier are updated in the database on the basis of the captured data.

13. An arrangement for identifying animals, configured to carry out a method as claimed in claim 1.

14. A computer program product comprising a computer readable hardware storage device having computer readable program code stored therein, said program code executable by a processor of a computer system to implement a method configured to carry out a method as claimed in claim 1.

15. A computer-readable storage medium with a computer program product as claimed in claim 14.
